(19) United States
(12) Patent Application Publication
(10) Pub. No.: US 2015/0151822 A1
(43) Pub. Date: Jun. 4, 2015

(54) BOAT PROPULSION DEVICE

(71) Applicant: YAMAHA HATSUDOKI KABUSHIKI KAISHA, Iwata-shi (JP)

(72) Inventors: Hikaru YASUKAWA, Shizuoka (JP); Kouichi ISOZAKI, Shizuoka (JP)

(21) Appl. No.: 14/449,245

(22) Filed: Aug. 1, 2014

(30) Foreign Application Priority Data
Nov. 29, 2013 (JP) 2013-248258

(51) Int. Cl. B63H 20/32; B63H 20/00; H01T 13/04; B63H 23/34

(52) U.S. Cl. CPC B63H 20/32; B63H 23/34; B63H 20/00; H01T 13/04

(57) ABSTRACT

In a boat propulsion device, a head portion of an engine includes plug holes, first attachment portions, and a second attachment portion. The plug holes are aligned vertically and parallel or substantially parallel to a crankshaft. The first attachment portions are arranged on the periphery of the plurality of plug holes. The first attachment portions are configured to attach a plurality of ignition coils which are respectively integrated with spark plugs in a coil-on-plug configuration. A second attachment portion is provided separately from the first attachment portions. The second attachment portion is configured to attach an ignition coil connected to the spark plugs in a double ended ignition coil configuration via cables.

### BACKGROUND OF THE INVENTION

1. Field of the Invention

The present invention relates to a boat propulsion device.

2. Description of the Related Art

There are two types of engines for boat propulsion devices: engines which use spark plugs in a coil-on-plug configuration, and engines which use spark plugs in a double ended ignition coil configuration. For example, Japan Patent Laid-open Patent Publication JP-A-02-230965 discloses an engine provided with an ignition device with a coil-on-plug configuration.

In the coil-on-plug configuration, an ignition coil is incorporated with a spark plug, and controlling the conduction of current through each ignition coil controls the spark timing for each spark plug independently. On the other hand, in a double ended ignition coil configuration the ignition coil and spark plug are separate. The plurality of spark plugs in a double ended ignition coil configuration is connected to the same ignition coil via a cable. Controlling the conduction of current through the shared ignition coil ensures that multiple spark plugs will spark simultaneously with great accuracy.

### SUMMARY OF THE INVENTION

Recently there has been a desire in manufacturing to control production costs by standardizing components. However, standardizing the components for double ended ignition coil configurations and coil-on-plug configurations in which the spark plugs and ignition coils have different structures is no simple task.

Preferred embodiments of the present invention address this problem by providing a boat propulsion device wherein spark plugs may be used in either double ended ignition coil configurations or coil-on plug configurations, and wherein the standardizing of components leads to reduced production costs.

A boat propulsion device according to a preferred embodiment of the present invention includes an engine, a drive shaft, and a propeller shaft. The engine includes a crankshaft and a head portion. The crankshaft extends vertically. The head portion is arranged horizontally adjacent to the crankshaft. The drive shaft extends vertically and is connected to the crankshaft. The propeller shaft extends horizontally and is connected to the drive shaft. The head portion includes a plurality of plug holes, a plurality of first attachment portions, and a second attachment portion. The plurality of plug holes is aligned vertically, parallel or substantially parallel to the crankshaft. The plurality of first attachment portion is arranged on the periphery of the plurality of plug holes. The first attachment portions are configured to attach a plurality of integrated ignition coils which are respectively integrated with the plurality of spark plugs in a coil-on-plug configuration. A second attachment portion is provided separately from the first attachment portions. The second attachment portion is configured to attach a separated ignition coil connected to the spark plugs in a double ended ignition coil configuration via cables.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a side view of a boat propulsion device according to a preferred embodiment of the present invention.

FIG. 2 is a side view of an engine unit.

FIG. 3 is a rear view of the engine without a spark plug or ignition coil attached.

FIG. 4 is a partial cross-sectional view of the engine without the spark plug or ignition coil attached.

FIG. 5 is a rear view of the engine with a spark plug and integrated ignition coil attached in a coil-on-plug configuration.

FIG. 6 is a partial cross-sectional view of the engine with the spark plug and integrated ignition coil attached in a coil-on-plug configuration.

FIG. 7 is a perspective view of a first cable holder.

FIG. 8 is a perspective view of a second cable holder.

FIG. 9 is a rear view of the engine with a spark plug and separated ignition coil attached in a double ended ignition coil.

FIG. 10 is a partial cross-sectional view of the engine with the spark plug and separated ignition coil attached in a double ended ignition coil configuration.

FIG. 11 is a perspective view of a third cable holder.

### DETAILED DESCRIPTION OF THE PREFERRED EMBODIMENTS

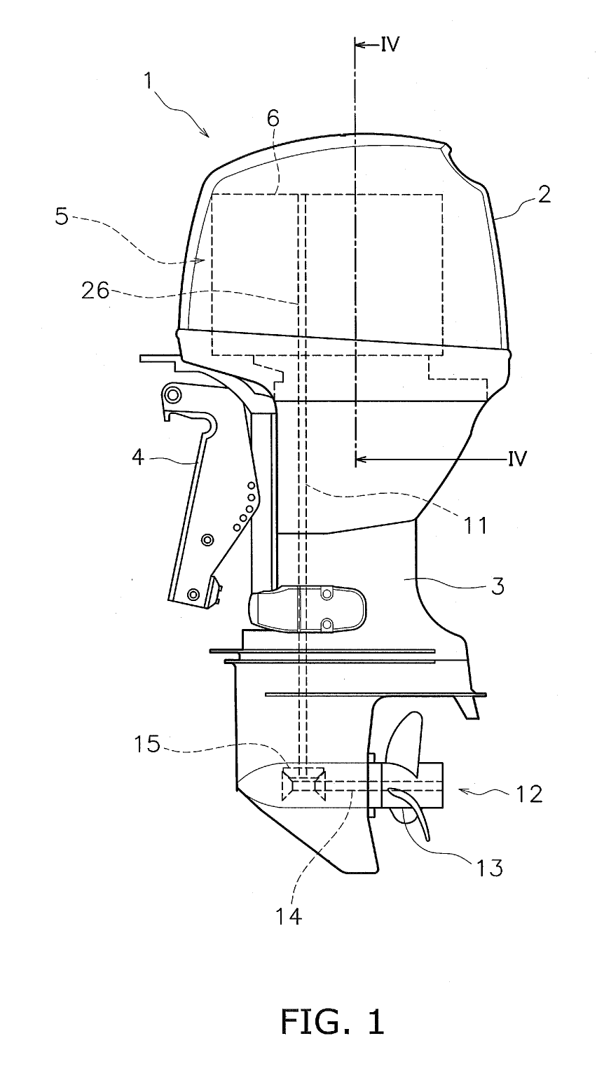

Various preferred embodiments of a boat propulsion device will be described below with reference to the drawings. FIG. 1 is a side view of a boat propulsion device 1 according to a preferred embodiment of the present invention. The boat propulsion device 1 is preferably an outboard motor, for example. The boat propulsion device 1 includes an engine cover 2, a casing 3, a bracket 4, and an engine unit 5. The engine cover 2 houses the engine unit 5. The casing 3 is arranged below the engine cover 2. The boat propulsion device 1 is attached to a hull via the bracket 4.

The engine unit 5 is placed inside the engine cover 2. The engine unit 5 includes an engine 6. A drive shaft 11 is arranged inside the casing 3. The drive shaft 11 extends vertically inside the casing 3. The drive shaft 11 is fixed to a crankshaft 26 of the engine 6. A propeller 12 is arranged at the lower portion of the casing 3. The propeller 12 is arranged below the engine 6. The propeller 12 includes a propeller hub 13. A propeller shaft 14 is arranged inside the propeller hub 13. The propeller shaft 14 extends longitudinally. The propeller shaft 14 is coupled to the lower portion of the drive shaft 11 through a bevel gear 15.

In the boat propulsion device 1, the drive shaft 11 and the propeller shaft 14 transfer the driving power produced by the engine 6 to the propeller 12. The driving power transferred to the propeller 12 causes the propeller 12 to rotate forwards or backwards. This forwards or backwards rotation of the propeller 12 produces travel power that causes a boat provided with the boat propulsion device 1 to travel forward or backward.

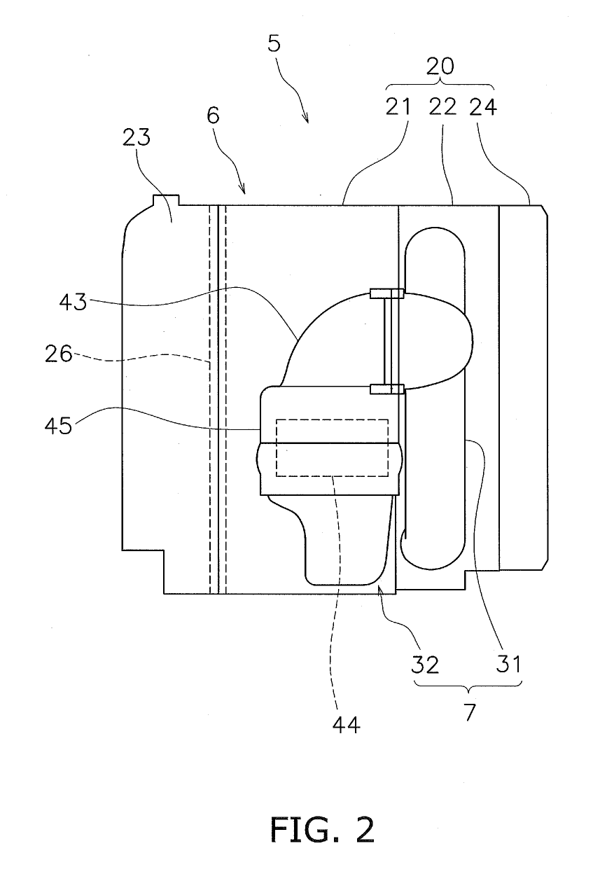

FIG. 2 is a side view of the engine unit 5. As illustrated in FIG. 2, the engine 6 includes a head portion 20 and a crankcase 23. The head portion 20 is arranged horizontally adjacent to the crankshaft 26. The head portion 20 includes a cylinder block 21, a cylinder head 22, and a head cover 24. The cylinder head 22 is arranged behind the cylinder block 21. The head cover 24 is arranged behind the cylinder head 22. The crankcase 23 is arranged in front of the cylinder block 21.

The crankshaft 26 is arranged inside the crankcase 23. The crankshaft 26 extends vertically. The upper end portion of the drive shaft 11 is coupled to the lower end portion of the crankshaft 26. The movement of a plurality of pistons (not shown) arranged inside the cylinder block 21 is transmitted to the drive shaft 11 via the crankshaft 26.

The engine unit 5 includes an exhaust pipe 7. The exhaust pipe 7 is arranged beside the engine 6. The exhaust pipe 7 is connected to the engine 6. More specifically, the exhaust pipe 7 includes an exhaust manifold 31 and a catalyst unit 32. The exhaust manifold 31 is connected to the engine 6. The catalyst unit 32 is connected to the exhaust manifold 31. The exhaust manifold 31 is arranged beside the cylinder head 22. The exhaust manifold 31 extends vertically. The exhaust manifold 31 is connected to the cylinder head 22.

The catalyst unit 32 is arranged beside the cylinder block 21. The catalyst unit 32 includes a connecting tube 43, catalyst member 44, and a catalyst storage tube 45. The connecting tube 43 is connected to the catalyst storage tube 45. The connecting tube 43 is located above the catalyst storage tube 45. The connecting tube 43 connects the catalyst storage tube 45 and the exhaust manifold 31. The connecting tube 43 is shaped to curve from the upper end of the catalyst storage tube 45 toward the exhaust manifold 31.

The catalyst member 44 is arranged inside the catalyst storage tube 45. The catalyst member 44 supports a catalyst that purifies the exhaust. For example, a three-way catalyst is preferably used. The exhaust traveling through the exhaust pipe 7 passes through the catalyst member 44 inside the catalyst storage tube 45 and is purified. The catalyst storage tube 45 is arranged next to the exhaust manifold 31 in the longitudinal direction of the boat propulsion device 1. The catalyst storage tube 45 is arranged to extend vertically.

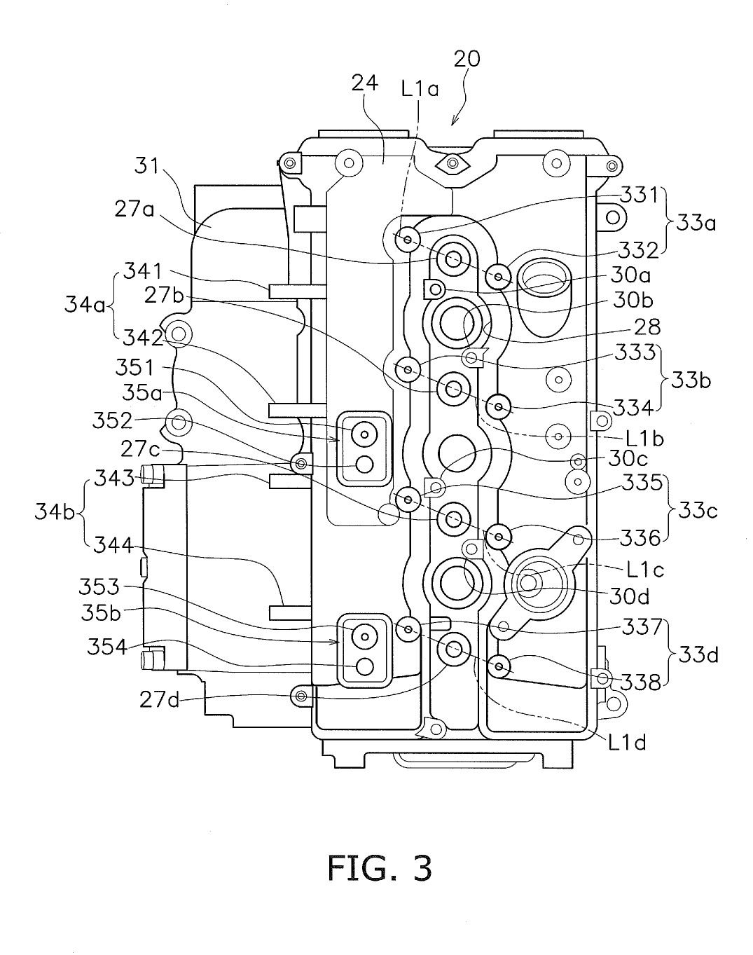

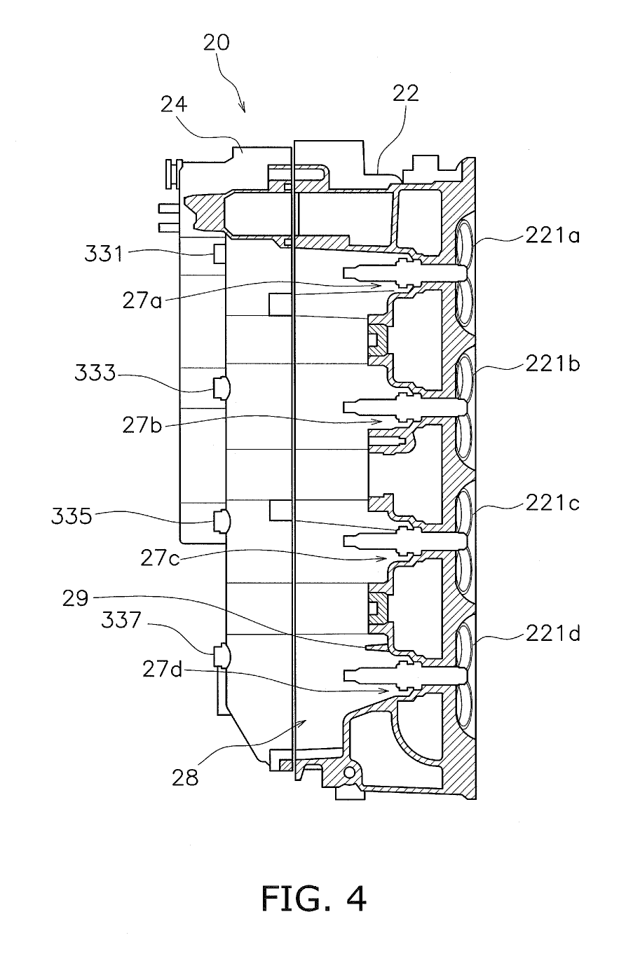

FIG. 3 is a rear view of the engine 6 without a spark plug or ignition coil attached. FIG. 4 is a cross-sectional view of the head cover 24 and the cylinder head 22 without the spark plug or ignition coil attached.

As illustrated in FIG. 3 and FIG. 4, the head portion 20 includes a plurality of plug holes 27a to 27d configured to receive spark plugs. In the present preferred embodiment, the head portion 20 includes a first plug hole 27a, a second plug hole 27b, a third plug hole 27c, and a fourth plug hole 27d. The first through fourth plug holes 27a to 27d are aligned vertically and parallel or substantially parallel to the crankshaft 26. The first through fourth plug holes 27a to 27d respectively extend in the longitudinal direction. As illustrated in FIG. 3, the first through fourth plug holes 27a to 27d respectively extend through the head cover 24 and the cylinder head 22 to the combustion chambers 221a to 221d in the cylinder head 22.

As illustrated in FIG. 3, the head portion 20 includes a vertically extending trench 28. The trench 28 connects the plurality of plug holes 27a to 27d to each other. As illustrated in FIG. 4, the cylinder head 22 includes a rib 29 between the third plug hole 27c and the fourth plug hole 27d within the trench 28. As illustrated in FIG. 3, bolt seats 30a and 30b are provided between the first plug hole 27a and the second plug hole 27b. Furthermore, a bolt seat 30c is provided between the second plug hole 27b and the third plug hole 27c. A bolt seat 30d is provided between the third plug hole 27c and the fourth plug hole 27d. The bolt seats 30a to 30d are configured to protrude from the edge of the trench 28 towards the trench 28.

As illustrated in FIG. 3, the head cover 24 includes first attachment portions 33a to 33d and second attachment portions 34a and 34b. The first attachment portions 33a to 33d are configured to attach the plurality of ignition coils (hereafter referred to as “integrated coils”) which are respectively integrated with the plurality of spark plugs in a coil-on-plug configuration (described below). The first attachment portions 33a to 33d correspond to each of the plurality of plug holes 27a to 27d. Therefore, the same number of first attachment portions 33a to 33d as a plurality of spark plugs in a coil-on-plug configuration are provided in the head cover 24. The first attachment portions 33a to 33d are arranged around peripheries of the plurality of plug holes 27a to 27d. More specifically, the first attachment portion 33a arranged on the periphery of the first plug hole 27a includes a first fastening hole 331 and a second fastening hole 332. The first plug hole 27a is arranged between the first fastening hole 331 and the second fastening hole 332.

Bolts that secure an integrated coil for the coil-on-plug configuration are tightened to the first fastening hole 331 and the second fastening hole 332. The first fastening hole 331 and the second fastening hole 332 are preferably horizontally separated from each other. Further, an imaginary line L1a connecting the centers of the first fastening hole 331 and the second fastening hole 332 preferably slants with respect to the vertical direction. The imaginary line L1a and the first plug hole 27a overlaps when the engine 6 is viewed from the rear.

The first attachment portion 33b corresponding to the second plug hole 27b includes a first fastening hole 333 and a second fastening hole 334. An imaginary line Lib connecting the centers of the first fastening hole 333 and the second fastening hole 334 preferably slants with respect to the vertical direction. The first attachment portion 33c corresponding to the third plug hole 27c includes a first fastening hole 335 and a second fastening hole 336. Further, an imaginary line L1c connecting the centers of the first fastening hole 335 and the second fastening hole 336 preferably slants with respect to the vertical direction. The first attachment portion 33d corresponding to the fourth plug hole 27d includes a first fastening hole 337 and a second fastening hole 338. Further, an imaginary line L1d connecting the centers of the first fastening hole 337 and the second fastening hole 338 preferably slants with respect to the vertical direction. The imaginary lines L1a to L1d respectively slant in the same direction and are mutually parallel or substantially parallel. The first attachment portions 33b to 33d preferably have the same configuration as the above described first attachment portion 33a, and therefore a detailed explanation thereof will be omitted.

Second attachment portions 34a and 34b are provided separately from the first attachment portions 33a to 33d. The second attachment portions 34a and 34b are configured to attach the plurality of ignition coils (hereafter, “separated coils”), which are respectively connected to the plurality of spark plugs in a double ended ignition coil configuration (described below) via cables. The number of the second attachment portions 34a and 34b is smaller than the number of plug holes 27a to 27d. In the present preferred embodiment, two second attachment portions 34a and 34b are provided in the head cover 24. However, the head cover 24 may be provided with only a single second attachment portion. The two second attachment portions 34a and 34b are aligned vertically.

The second attachment portions 34a and 34b are provided on the side surface of the head cover 24. The second attachment portion 34a includes a first support portion 341 and a second support portion 342. Each of the support portions 341 and 342 projects laterally from the side surface of the head cover 24. Each of the supports 341 and 342 is provided with a fastening hole (not shown); where the separated coil in the double ended ignition coil configuration is secured to each of the supports 341 and 342 with bolts. The second attachment portion 34a is located below the upper end of the trench 28. The second attachment portion 34b is located above the lower end of the trench 28. The second attachment portion 34b, which is located below the second attachment portion 34a, includes a first support portion 343 and a second support portion 344. The second attachment portion 34b preferably has the same configuration as the above described second attachment portion 34a, and therefore a detailed explanation thereof will be omitted.

The head portion 20 includes a third attachment portion 35a and 35b. The third attachment portion 35a and 35b is configured to attach a cable holder (described below). Two third attachment portions 35a and 35b are provided in the present preferred embodiment. The third attachment portions 35a and 35b are aligned vertically. The third attachment portion 35a is arranged beside the trench 28 on the head cover 24. The third attachment portion 35a is provided between the second attachment portions 34a and 34b and the trench 28 in the lateral direction.

The third attachment portion 35b, which is located below the second attachment portion 35a, includes a first projection 353 and a second projection 354. The third attachment portion 35b preferably has the same configuration as the above described third attachment portion 35a, and therefore a detailed explanation thereof will be omitted.

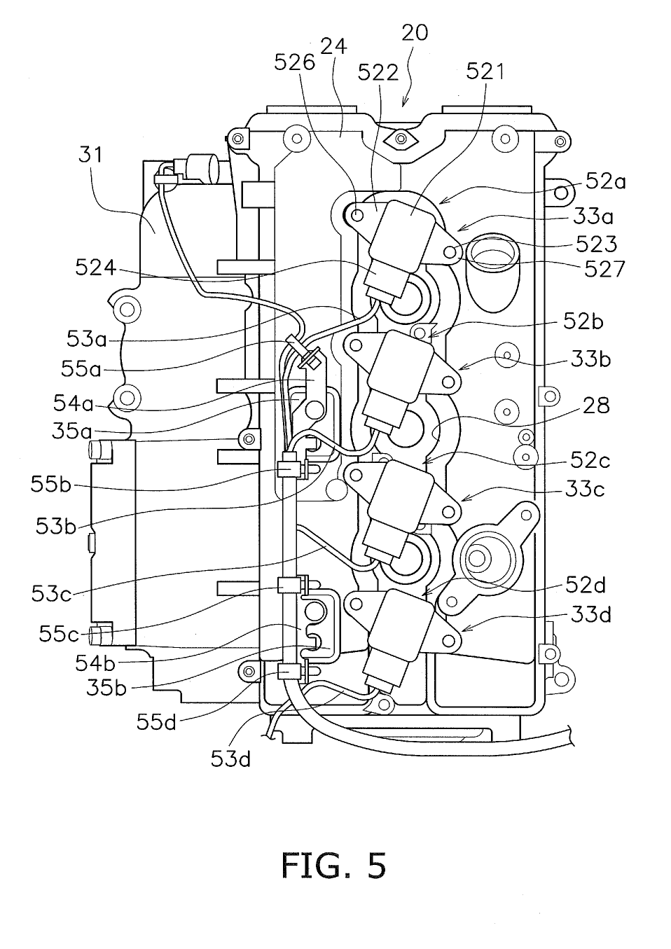

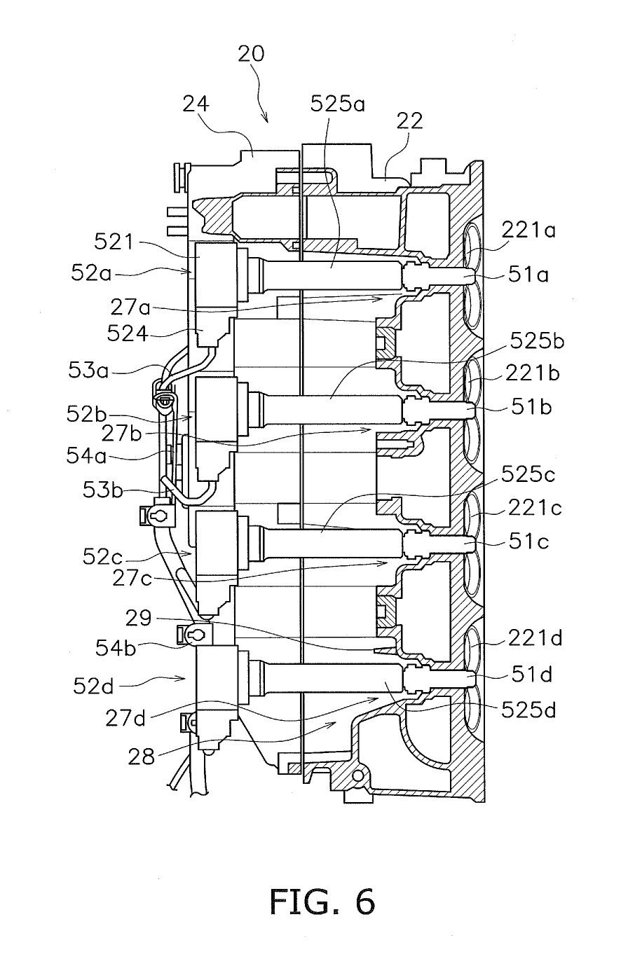

FIG. 5 is a rear view of the engine 6 with spark plugs 51a to 51d and integrated coils 52a to 52d attached in a coil-on-plug configuration. FIG. 6 is a cross-sectional view of the head cover 24 and the cylinder head 22 with the spark plugs 51a to 51d and the integrated coils 52a to 52d attached in the coil-on-plug configuration.

As illustrated in FIG. 6 the plurality of spark plugs 51a to 51d for the coil-on-plug configuration are plugged into the respective plurality of plug holes 27a to 27d. More specifically, a first spark plug 51a is plugged into the first plug hole 27a. Furthermore, a first integrated coil 52a is integrated with the first spark plug 51a. A second spark plug 51b is plugged into the second plug hole 27b. Furthermore, a second integrated coil 52b is integrated with the second spark plug 51b. A third spark plug 51c is plugged into the third plug hole 27c. Furthermore, a third integrated coil 52c is integrated with the third spark plug 51c. Finally, a fourth spark plug 51d is plugged into the fourth plug hole 27d. Furthermore, a fourth integrated coil 52d is integrated with the fourth spark plug 51d.

While the first spark plug 51a and first integrated coil 52a will be described below, the second through fourth spark plugs 51b to 51d and second through fourth integrated coils 52b to 52d preferably have the same configuration.

As illustrated in FIG. 5, the first integrated coil 52a is attached at the first attachment portion 33a. The first integrated coil 52a includes the coil body 521, a first fixed flange 522, a second fixed flange 523, a connector 524, and a plug boot 525a.

The coil body 521 houses windings and an iron core (not shown), and increases the voltage input thereto. The coil body 521 appears square or substantially square when viewed from the rear. The longitudinal direction of the coil body 521 preferably slants with respect to the vertical direction. The coil body 521 is located behind the trench 28.

The first fixed flange 522 protrudes from one side surface of the coil body 521. The second fixed flange 523 protrudes from the other side surface of the coil body 521. The fixed flanges 522 and 523 are configured to attach the first integrated coil 52a to the first attachment portion 33a. The fixed flanges 522 and 523 have holes provided therein. A bolt 526 extends through the hole in the first fixed flange 522 to attach the first integrated coil 52a to the first fastening hole 331 of the first attachment portion 33a. A bolt 527 extends through the hole in the second fixed flange 523 to attach the first integrated coil 52a to the second fastening hole 332 of the first attachment portion 33a.

The connector 524 protrudes from the coil body 521. A first cable 53, which supplies electricity to the coil body 521, is connected to the connector 524. More specifically, the connector 524 protrudes from the lower surface of the coil body 521 in a direction parallel or substantially parallel to the longitudinal direction of the coil body 521. Therefore, the connector 524 protrudes from the coil body 521 in a direction that slants with respect to the vertical direction. More specifically, the connector 524 extends laterally and downward from the coil body 521.

As illustrated in FIG. 6, the plug boot 525a protrudes from the coil body 521. The plug boot 525a is arranged inside the trench 28. The plug boot 525a is preferably made of an insulating material such as rubber. The plug boot 525a includes a through hole. The end of the first spark plug 51a is inserted into the through hole of the plug boot 525a to connect the first spark plug 51a and first integrated coil 52a.

The first cable 53a is connected to the first integrated coil 52a. A second cable 53b is connected to the second integrated coil 52b. A third cable 53c is connected to the third integrated coil 52c. A fourth cable 53d is connected to the fourth integrated coil 52d.

The second integrated coil 52b includes a plug boot 525b. Inserting the end of the second spark plug 51b into the through hole of the plug boot 525b connects the second integrated coil 52b and the second spark plug 51b. The third integrated coil 52c includes a plug boot 525c. Inserting the end of the third spark plug 51c into the through hole of the plug boot 525c connects the third integrated coil 52c and the third spark plug 51c. The fourth integrated coil 52d includes a plug boot 525d. Inserting the end of the fourth spark plug 51d into the through hole of the plug boot 525d connects the fourth integrated coil 52d and the fourth spark plug 51d.

Cable holders 54a and 54b are preferably attached to the third attachment portion 35a and 35b to hold cables 53a to 53d. The cable holders 54a and 54b hold the cables 53a to 53d which are connected to the integrated coils 52a to 52d. A first cable holder 54a is attached to the third attachment portion 35a. A second cable holder 54b is attached to the third attachment portion 35b which is located lower than the third attachment portion 35a.

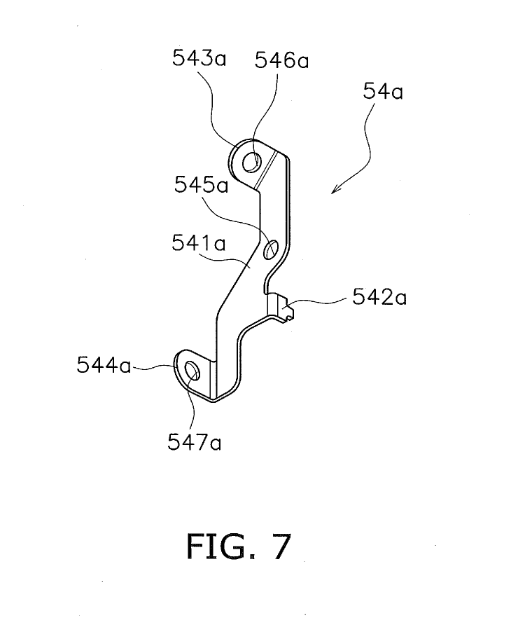

FIG. 7 is a perspective view of the first cable holder 54a. The first cable holder 54a includes a first main section 541a, a first projection 542a, a first holder 543a, and a second holder 544a. The first main section 541a is a vertically extending plate. The first main section 541a is provided with a hole 545a. The projection 351 on the third attachment portion 35a is inserted into the hole 545a in the first main section 541a. The first projection 542a projects in a direction that is orthogonal or substantially orthogonal to the first main section 541a. The first holder 543a and the second holder 544a project in another direction orthogonal or substantially orthogonal to the first main section 541a. The first projection 542a engages with a recess 352 in the third attachment portion 35a to prevent the rotation of the first cable holder 54a.

The first holder 543a is provided with a hole 546a. The second holder 544a is provided with a hole 547a. A first cable binder 55a (refer to FIG. 5) is preferably attached to the first holder 543a to bundle cables together. A second cable binder 55b (refer to FIG. 5) is preferably attached to the second holder 544a to bundle cables together. The first holder 543a and the second holder 544a are preferably arranged laterally separated from each other to coincide with the position at which the first cable binder 55a and the second cable binder 55b bundle the cables together.

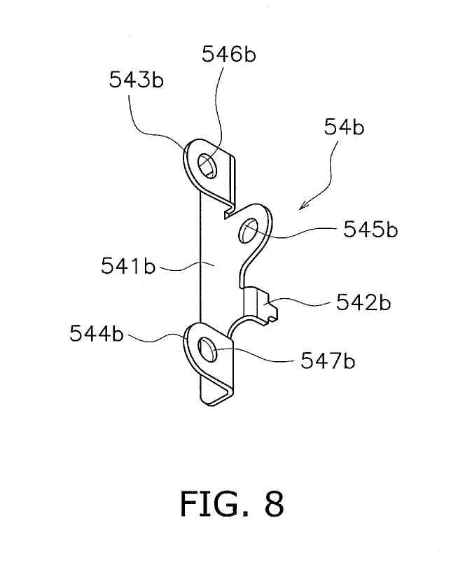

FIG. 8 is a perspective view of the second cable holder 54b. The second cable holder 54b includes a second main section 541b, second projection 542b, third holder 543b, and a fourth holder 544b. The second main section 541b is a vertically extending plate. The second main section 541b is provided with a hole 545b. The projection 353 on the third attachment portion 35b is inserted into the hole 545b in the second main section 541b. The second projection 542b projects toward one direction orthogonal or substantially orthogonal to the second main section 541b. The third holder 543b and the fourth holder 544b project toward the other direction orthogonal or substantially orthogonal to the second main section 541b. The second projection 542b engages with a recess 354 in the third attachment portion 35b to prevent the rotation of the second cable holder 54b. The third holder 543b is provided with a hole 546b. The fourth holder 544b is provided with a hole 547b. A third cable binder 55c (refer to FIG. 5) is preferably attached to the third holder 543b to bundle cables together. A fourth cable binder 55d (refer to FIG. 5) is preferably attached to the fourth holder 544b to bundle cables together. The positions where the third cable binder 55c and the fourth cable binder 55d bundle cables together are aligned vertically.

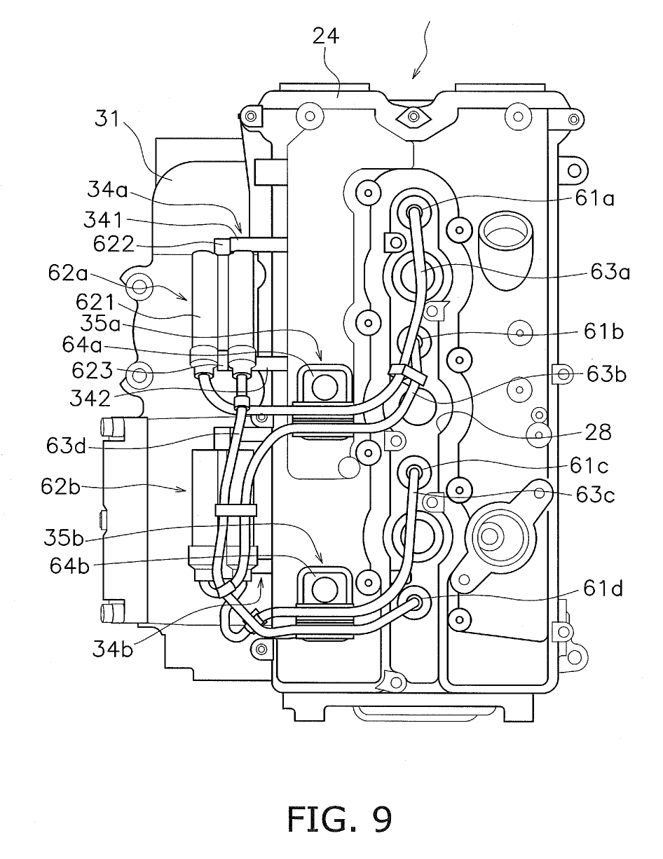

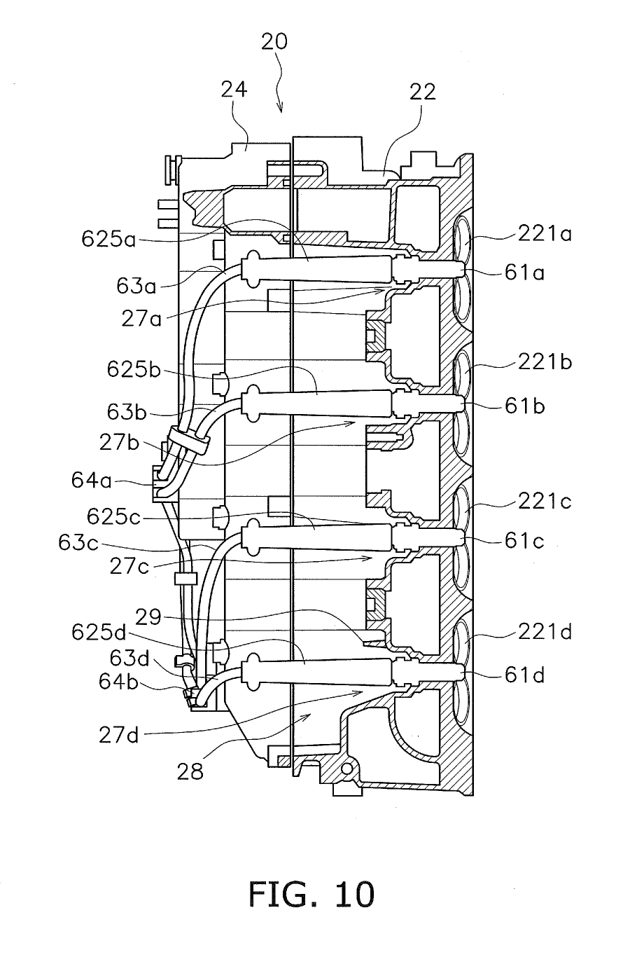

FIG. 9 is a rear view of the engine 6 with spark plugs 61a to 61d and separated coils 62a and 62b attached in a double ended ignition coil configuration. FIG. 10 is a cross-sectional view of the head cover 24 and the cylinder head 22 with the spark plugs 61a to 61d and the separated coils 62a and 62b attached in the double ended ignition coil configuration.

The plurality of sparks plugs 61a to 61d of the double ended ignition coil configuration is plugged into the respective plurality of plug holes 27a to 27d. More specifically, the first spark plug 61a is plugged into the first plug hole 27a. The second spark plug 61b is plugged into the second plug hole 27b. The third spark plug 61c is plugged into the third plug hole 27c. Finally, the fourth spark plug 61d is plugged into the fourth plug hole 27d.

The first spark plug is connected to the first separated coil 62a via a first cable 63a. The fourth spark plug 61d is connected to the first separated coil 62a via fourth cable 63d. Accordingly, the first separated coil 62a supplies electricity to the first spark plug 61a and the fourth spark plug 61d. The second spark plug 51b is connected to the second separated coil 62b via a second cable 63b. The third spark plug 51c is connected to the second separated coil 62b via a third cable 63c. Accordingly, the second separated coil 62b supplies electricity to the second spark plug 51b and the third spark plug 51c.

The first separated coil 62a is attached at the second attachment portion 34a. The first separated coil 62a includes a coil body 621, a first fixed portion 622, and a second fixed portion 623. The coil body 621 houses windings and an iron core (not shown), and increases the voltage input thereto. The coil body 621 is located beside the head cover 24.

The first fixed portion 622 protrudes from the upper surface of the coil body 621. The second fixed portion 623 protrudes from the lower surface of the coil body 621. The first fixed portion 622 and the second fixed portion 623 are configured to attach the first separated coil 62a to the second attachment portion 34a. The first fixed portion 622 is secured to the first support portion 341. The second fixed portion 623 is secured to the second support portion 342. Each fixed portion 622 and 623 includes a hole provided therein so that the bolts (not shown) used to attach the first separated coil 62a to the second attachment portion 34a pass through the hole in each fixed portion 622 and 623.

As illustrated in FIG. 10, a first plug boot 625a is connected to the first cable 63a. The first plug boot 625a includes a through hole, and the end portion of the first spark plug 61a is inserted into the through hole in the first plug boot 625a. The fourth plug boot 625d is connected to the fourth cable 63d. The fourth plug boot 625d includes a through hole, and the end portion of the fourth spark plug 61d is inserted into the through hole in the fourth plug boot 625d.

The second plug boot 625b is connected to the second cable 63b. The second plug boot 625b includes a through hole, and the end portion of the second spark plug 61b is inserted into the through hole in the second plug boot 625b. The third plug boot 625c is connected to the third cable 63c. The third plug boot 625c includes a through hole, and the end portion of the third spark plug 61c is inserted into the through hole in the third plug boot 625c.

The first through fourth plug boots 625a to 625d are arranged inside the trench 28. The first through fourth plug boots 625a to 625d are preferably made of an insulating material such as rubber.

The second spark plug 51b, third spark plug 51c, and the second separated coil 62b have the same configuration as the first spark plug 51b, the fourth spark plug 51d, and the first separated coil 62a, and therefore a detailed explanation thereof will be omitted.

A third cable holder 64a is preferably attached to the third attachment portion 35a to hold cables. A fourth cable holder 64b is preferably attached to the third attachment portion 35b to hold cables. The third cable holder 64a holds the first cable 63a and the second cable 63b. The fourth cable holder 64b holds the third cable 63c and the fourth cable 63d.

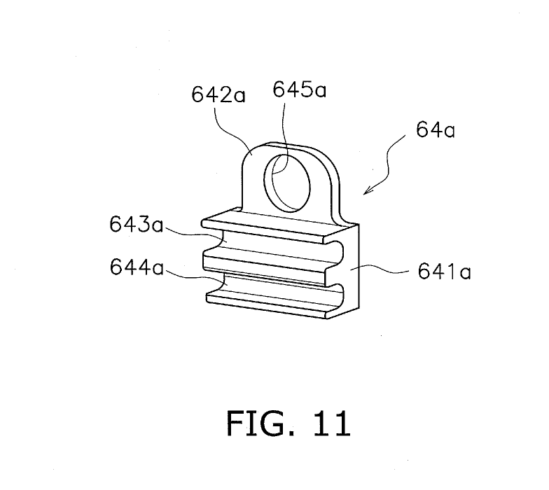

FIG. 11 is a perspective view of the third cable holder 64a. The third cable holder 64a includes a main section 641a and a flange 642a. The main section 641a includes a first groove 643a and a second groove 644a configured to hold cables. The first cable 63a is held in the first groove 643a. The second cable 63b is held in the second groove 644a. The flange 642a is provided with a hole 645a. The projection 351 on the third attachment portion 35a is inserted into the hole 645a in the flange 642a. The first groove 643a and second groove 644a are provided in the surface on one side of the main section 641a and a projection (not shown) is provided on the surface on the other side of the main section 641a. The projection engages with a recess 352 in the third attachment portion 35a to prevent the rotation of the third cable holder 64a. The fourth cable holder 64b preferably has the same configuration as the third cable holder 64a, and therefore a detailed explanation thereof will be omitted.

The boat propulsion device according to the described preferred embodiments include the following features.

When spark plugs 51a to 51d are used with the engine 6 in the coil-on-plug configuration, the plurality of integrated coils 52a to 52d which correspond to the plurality of spark plugs 51a to 51d are preferably each attached to the plurality of first attachment portions 33a to 33d. Furthermore, when the spark plugs 61a to 61d are used in the double ended ignition coil configuration, the separated coils 62a and 62b shared among the plurality of spark plugs 61a to 61d are preferably attached at the second attachment portions 34a and 34b. Consequently, both of the spark plugs for the coil-on-plug configuration and the spark plugs for the double ended ignition coil configuration may be used, and the standardizing of components leads to reduced production costs.

The trench 28 in the head portion 20 connects the plurality of plug holes 27a to 27d to each other. Even if the plug boots 525a to 525d for the integrated coils 52a to 52d and the plug boots 625a to 625d connected to the separated coils 62a and 62b have a different shape, the trench facilitates attachment of the plug boots to the spark plugs.

The head portion 20 includes a rib 29 arranged between plug holes 27c and 27d in the trench 28. As a result, when a worker plugs the plug boot 525d or the plug boot 625d into the trench 28, the rib 29 prevents the worker from misplacing the plug boot 525d or the plug boot 625d between the plug holes 27c and 27d. Moreover, the bolt seats 30a to 30d provided in the trench 28 prevent misplacement of the plug boots between the other plug holes. The same kind of bolt seats as the bolt seats 30a to 30d may be substituted for the rib 29 to prevent the plug boot 525d or the plug boot 625d from being placed between the plug holes 27c and 27d.

The plurality of imaginary lines L1a to L1d for the first attachment portions 33a to 33d preferably slant with respect to the vertical direction. Therefore, the plurality of integrated coils 52a to 52d will preferably slant with respect to the vertical direction. Slanting the plurality of integrated coils allows a compact arrangement of the plurality of integrated coils 52a to 52d in the head cover 24.

The first cable holder 54a and the second cable holder 54b are preferably attached to the third attachment portions 35a and 35b. Alternatively, the third cable holder 64a and the fourth cable holder 64b may be attached to the third attachment portion 35a and 35b. Therefore, the cables are held securely. Additionally, the third attachment portions 35a and 35b are preferably shared to attach the first cable holder 54a and the second cable holder 54b, and to attach the third cable holder 64a and the fourth cable holder 64b.

The above description refers to various preferred embodiments of the present invention, but the present invention is not limited to the above preferred embodiments and may be modified in various ways insofar as the modifications do not depart from the spirit and scope of the invention.

While the above preferred embodiments refer to an outboard motor as an example of a boat propulsion device, the present invention may be used in other types of boat propulsion devices such as stern drives.

Furthermore, the number of spark plugs and plug holes need not be limited to four as in the above preferred embodiments. The number of spark plugs or plug holes may be fewer or greater than four. Furthermore, the number of integrated coils need not be limited to four as in the above preferred embodiments. The number of integrated coils may be fewer or greater than four. Further, the number of separated coils need not be limited to two as in the above preferred embodiments. There may be one, or more than three separated coils.

The imaginary lines L1a to L1d may be parallel or substantially parallel to the vertical direction. Alternatively, the imaginary lines L1a to L1d may be parallel or substantially parallel to the horizontal direction.

Without being limited to the above preferred embodiments, the position of the first attachment portions 33a to 33d may be varied. Without being limited to the above preferred embodiments, the position of the second attachment portions 34a and 34b may be varied. Without being limited to the above preferred embodiments, the position of the third attachment portions 35a and 35b may be varied. For example, the third attachment portions 35a and 35b may be provided in the cylinder head 22 and not in the head cover 24.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A boat propulsion device comprising:
an engine including a crankshaft extending in a vertical direction and ahead portion arranged horizontally adjacent to the crankshaft;
a drive shaft extending in the vertical direction and connected to the crankshaft; and
a propeller shaft extending in a horizontal direction and connected to the drive shaft; wherein
the head portion includes:
a plurality of plug holes aligned in the vertical direction and arranged parallel or substantially parallel to the crankshaft;
a plurality of first attachment portions arranged about a periphery of the plurality of plug holes, the plurality of first attachment portions configured to attach a plurality of integrated coils integrated with a plurality of spark plugs in a coil-on-plug configuration; and
a second attachment portion provided separately from the plurality of first attachment portions, the second attachment portion configured to attach a separated coil connected via a plurality of cables to a plurality of spark plugs in a double ended ignition coil configuration.

2. The boat propulsion device according to claim 1, wherein the head portion includes a trench extending in the vertical direction, and the trench connects the plurality of plug holes to each other.

3. The boat propulsion device according to claim 2, wherein the head portion includes a rib arranged in the trench between at least two of the plurality of plug holes.

4. The boat propulsion device according to claim 1, wherein the plurality of first attachment portions include:
a plurality of first fastening holes and a plurality of second fastening holes corresponding to each of the plurality of plug holes;
each of the plurality of plug holes is arranged between a corresponding first fastening hole and a corresponding second fastening hole; and
a plurality of imaginary lines connecting respective centers of the first fastening holes and the second fastening holes are slanted with respect to the vertical direction.

5. The boat propulsion device according to claim 1, wherein the head portion includes a third attachment portion configured to attach a cable holder configured to hold a cable.

6. The boat propulsion device according to claim 5, further comprising:
the plurality of spark plugs in the coil-on-plug configuration plugged into each of the plug holes;
the plurality of integrated coils attached to the plurality of first attachment portions, the plurality of integrated coils respectively integrated with the spark plugs;
a plurality of cables connected to each of the plurality of integrated coils; and
the cable holder attached to the third attachment portion, the cable holder configured to hold the plurality of cables.

7. The boat propulsion device according to claim 5, further comprising:
the plurality of spark plugs in a double ended ignition coil configuration plugged into each of the plurality of plug holes;
the separated coil attached to the second attachment portion;
the plurality of the cables connecting the separated coil and the plurality of spark plugs in the double ended ignition coil configuration; and
the cable holder attached to the third attachment portion, the cable holder configured to holding the plurality of cables.
